(19) United States
(12) Patent Application Publication
(10) Pub. No.: US 2007/0234608 A1
(43) Pub. Date: Oct. 11, 2007

(54) Lighted display for graphic artwork

(76) Inventor: David J. Morrison, Las Vegas, NV (US)

Correspondence Address: LITMAN LAW OFFICES, LTD., P.O. BOX 15035, CRYSTAL CITY STATION, ARLINGTON, VA, 22215, US

(21) Appl. No.: 11/373,094

(22) Filed: Mar. 13, 2006

(51) Int. Cl. G09F 13/18

(52) U.S. Cl. 40/546

(57) ABSTRACT

The lighted display for graphic artwork comprises a graphic artwork display article that can be removably placed on a platform above an electrically lighted display device for illumination of the graphic artwork. The display article of the present invention may utilize various combinations of translucent, transparent and opaque mounting plates for sandwiching graphic artwork images between at least two of the plates. Additionally, an opaque backer board may be provided as a divider that can be inserted between the two plates to separate artwork displayed on opposing sides of the graphic artwork display article. A platform disposed above the light source has a light aperture for passage of light from the light source through the platform and onto the artwork on display. In addition, the platform has a mounting channel forming sidewalls, which are provided to allow for the temporary and removable placement of the graphic artwork display thereon.

### BACKGROUND OF THE INVENTION

1. Field of the Invention

The present invention relates to lighted picture displays, and more particularly to a lighted display for graphic artwork.

2. Description of the Related Art

Photographs, laser images, and various other types of graphic artwork are placed on display in the home, in the office, and at other locations. Sometimes the graphic artwork includes depictions of loved ones, scenes that recall a favorite moment from a vacation or athletic contest, or simply reflect an image that strikes a responsive chord in the viewer because of its beauty, grandeur, artistic lines, or other aesthetic appeal. Conventional graphic artwork displays are available with frames having different shapes or colors that may coordinate well with a particular artwork image, but still other artwork would benefit from being lighted. Some lighting systems are internal, yet do not permit viewing of graphic images from opposing directions. Other lighting systems are available that are external to the artwork display piece, but such systems may be cumbersome and expensive.

With advances in technology, it is now possible to faithfully reproduce a photographic image as an etching or engraving in an appropriate substrate, e.g., glass, polycarbonate, acrylics, etc. through laser etching or other processes. Processes for etching indicia, such as selected text, into such substrates are also economically available. A lighted display that may accommodate a conventional paper photographic image, an engraved or etched photographic image, or other graphic artwork, and that includes an economical light source for obliquely illuminating either single or multiple images from opposing directions for enhanced aesthetic appeal, and that may also include engraved text or indicia appropriate to the image, would be desirable.

Thus, a lighted display for graphic artwork solving the aforementioned problems is desired.

### SUMMARY OF THE INVENTION

The lighted display for graphic artwork comprises a graphic artwork display that can be removably placed on a platform above an electrically lighted display device for illumination of the graphic artwork.

The display article of the present invention may utilize various combinations of translucent, transparent and opaque mounting plates for sandwiching a graphic artwork image or images between at least two of the plates. Additionally, an opaque backer board may be provided as a divider that can be inserted between the two plates to separate artwork displayed on opposing sides of the graphic artwork display article. A platform disposed above the light source has a light aperture for passage of light from the light source through the platform and onto the artwork on display. In addition, the platform has a mounting channel, which is provided to allow for the temporary and removable placement of the graphic artwork display article thereon.

These and other features of the present invention will become readily apparent upon further review of the following specification and drawings.

### BRIEF DESCRIPTION OF THE DRAWINGS

FIG. 1 is an environmental, perspective view of a lighted display for graphic artwork according to the present invention.

FIG. 2 is a partially exploded perspective view of the lighted display for graphic artwork according to the present invention.

Similar reference characters denote corresponding features consistently throughout the attached drawings.

### DETAILED DESCRIPTION OF THE PREFERRED EMBODIMENT

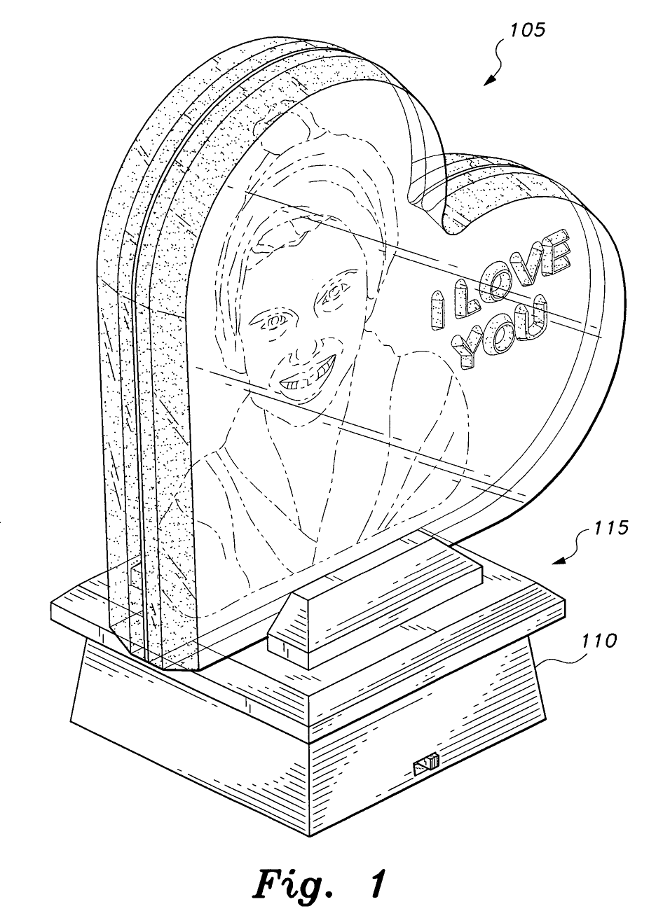

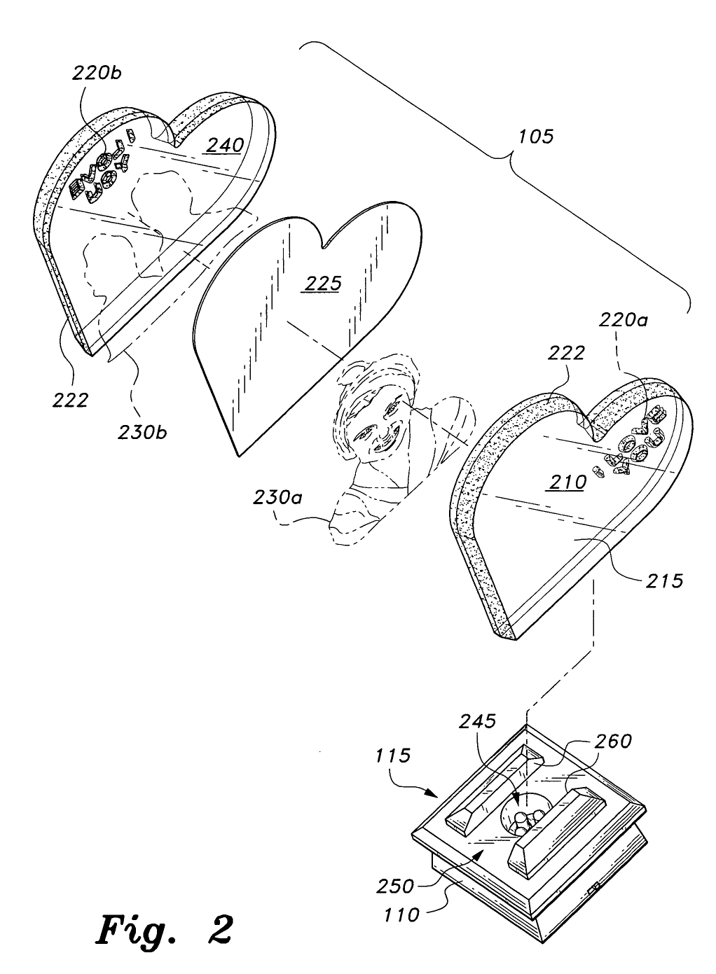

The present invention, as shown in FIGS. 1 and 2, is a lighted display for graphic artwork that comprises a graphic artwork display 105 that can be removably placed on a platform 115, which is disposed above an electrical light source 110 for illumination of photographs, engravings, laser art, and the like, such as photographs 230a and 230b, engraved indicia 220a and 220b, or a combination of a variety of graphic art images and engraving indicia. Additionally, graphic artwork display 105 is readily scalable from small desktop sizes to larger display sizes. For technical discussion of an exemplary electrical light source 110, U.S. Pat. No. 6,241,362, issued on Jun. 5, 2001 to Morrison, the present inventor, titled “Lighted Display Emitting Variable Colors,” is hereby incorporated by reference herein in its entirety.

The graphic art display 105 of the present invention may utilize various combinations of opaque, or clear or tinted translucent or transparent mounting plates, such as front mounting plate 210 and rear mounting plate 240, designed for sandwiching graphic art, such as photographs and/or laser-etched, routed, injection-molded, or other engraving artwork, within a plate or between at least two of the plates. Mounting plates intended to provide a viewing area should be made from a material that is permeable to visible light.

As shown in FIG. 2, an opaque backing material 225 may be provided as a divider that can be inserted behind the photographic image 230a to provide an opaque mounting surface for display of additional graphic art images on an opposing side of the display 105, such as photographic image 230b. It should be understood that graphic art images 230a and 230b may be viewed from opposing directions. For example, graphic image 230a may be viewed through front plate 210, while graphic image 230b may be viewed through rear plate 240. The opaque backing material 225 is particularly useful when the images 230a and 230b are transparent, e.g., laser-etched photographic images, in order to view the images from opposite sides of the display 105 without superposition or interference. The opaque backing material 225 may be a flexible sheet of opaque paper, an opaque foil, or a stiff board-like material, such as cardboard, a plastic material, and the like.

As shown in FIG. 2, the front mounting plate 210 is a translucent or transparent plate suitably adapted for allowing the graphic image 230a or engraving 220a to be viewed through the plate 210. The refractive properties of the mounting plate 210 add visual complexity to the photographic image 230a or other artwork on display. The front surface or face of mounting plate 210 preferably has a clear finish 215. The back surface, i.e., the contact surface of mounting plate 210, preferably is substantially smooth to provide a non-destructive area of contact with the graphic artwork 230a. Edges of the front mounting plate 210 may be beveled and/or have a matte finish 222. The front mounting plate 210 may also include the engraving 220a or other style of engraved or embossed indicia having a matte finish.

The rear mounting plate 240 is preferably translucent, transparent, or otherwise permeable to visible light to provide optical properties that are suitably adapted for allowing a graphic image, such as photograph 230b or engraving 220b, to be viewed through the plate 240. Additionally, edges of the rear mounting plate 240 may be beveled and/or have a matte finish 222. Preferably, rear mounting plate 240 has substantially the same geometric shape and dimension of front mounting plate 210. Optionally, the rear mounting plate 240 may be comprised of an opaque material of any color. In the event that rear mounting plate 240 is opaque, only graphic artwork placed between the backer board 225 and front mounting plate 210 is visible. Both front mounting plate 210 and rear mounting plate 240 may be made from a thermoplastic material, such as polycarbonate, acrylic or other suitable plastic having the desired translucent, transparent or opaque properties. Alternatively, front mounting plate 210 and rear mounting plate 240 may be made from glass having the desired translucent, transparent or opaque properties.

The photographic image 230a or other artwork may be sandwiched between the front mounting plate 210 and the rear mounting plate 240 so that the plates and photograph are coincident, thus forming a front display viewing area of image 230a through front mounting plate 210 of the display article 105.

Moreover, the opaque backing material 225 may be disposed between the rear plate 240 and photograph image 230a or other image displayed through the front mounting plate 210 to provide a rear display viewing area of any graphic image, such as photograph 230b, that may be disposed between the opaque backing material 225 and the rear mounting plate 240 of the display article 105. The graphic artwork displayed may be at least one paper photograph, at least one plate having at least one photographic image formed therein by laser etching or other process for transferring a photographic image to a substrate, or may be any other suitably flat graphic artwork comprising at least one image, pattern or indicia. The engraved indicia 220a and 220b may be text that includes messages or phrases appropriate for the graphic images on display, and may be engraved or etched into the front mounting plate 210, the rear mounting plate 240, or into a plate bearing the graphic images 230a and 230b. The engraved indicia may be formed by laser etching, by routing the substrate, by injection molding, or by any other engraving or etching process.

The platform 115 is preferably opaque and disposed above the light source 110. The platform 115 has a light aperture 245 defined therein for the passage of light from the light source 110 through the aperture 245 and into a mounting area for illumination of the display article 105. The platform 115 has a mounting guide 250 formed by two parallel elongate protrusions or mounting blocks creating opposing sidewalls 260 defining the mounting area and providing the capability of removably retaining the display article 105 within the mounting guide 250 in a stable manner, e.g., forming a compression or pressure fit of the display article 105 to the mounting platform 115, thereby clamping the front and rear mounting plates 210 and 240 together.

While a heart-shaped front mounting plate 210 and matching rear mounting plate 240 are shown in FIGS. 1 and 2, the present invention contemplates utilization of mounting plates having a variety of shapes and sizes.

While light source 110 is preferably the variable color emitting lighted display disclosed in applicant's prior patent, U.S. Pat. No. 6,241,362, which employs light emitting diodes (LEDs), a variety of different style light sources may be used in the present invention so long as the light source provided has the capability to illuminate all graphic images and indicia of the display article 105 contemporaneously.

It is to be understood that the present invention is not limited to the embodiment described above, but encompasses any and all embodiments within the scope of the following claims.

I claim:

1. A lighted graphic artwork display, comprising:
a front mounting plate made from a light permeable material;
a rear mounting plate, the front and rear mounting plates being adapted for holding a first graphic image therebetween in order to form the graphic artwork display, the first graphic image being visibly displayed through the front mounting plate;
a light source;
a platform mounted above the light source, the platform having a light aperture defined therein for passage of light from the light source through the platform and into the graphic artwork display for illuminating the first graphic image; and
a pair of parallel elongate protrusions forming opposing sidewalls mounted on the platform, the graphic artwork display being retained between the sidewalls.

2. The lighted graphic artwork display according to claim 1, wherein the front and rear mounting plates have substantially smooth contact surfaces adapted for facing the first graphic image and the front and rear mounting plates have substantially identical geometric shapes and dimensions.

3. The lighted graphic artwork display according to claim 1, wherein said rear mounting plate is made from a light permeable material, the display further comprising an opaque backing material disposed between said front mounting plate and said rear mounting plate, whereby the display is adapted for holding the first graphic image between said front mounting plate and the opaque backing material for viewing through said front mounting plate and for holding a second graphic image between said rear mounting plate and the opaque backing material for viewing through said rear mounting plate, both the first and second graphic images being lit by said light source.

4. The lighted graphic artwork display according to claim 1, wherein said front and rear mounting plates have a front surface having a clear finish.

5. The lighted graphic artwork display according to claim 1, wherein said front mounting plate and said rear mounting plate have beveled edges.

6. The lighted graphic artwork display according to claim 1, said front mounting plate and said rear mounting plate have a matte finish.

7. A lighted graphic artwork display, comprising:
a front mounting plate made from a light permeable material;
a rear mounting plate made from a light permeable material;.
an opaque backing material disposed between the front and rear mounting plates the front and rear mounting plates and the opaque backing material forming a graphic artwork display adapted for holding a first graphic image between the front mounting plate and the opaque backing material, and a second graphic image between the rear mounting plate and the opaque backing material so that the first and second graphic images are visible from opposite sides of the display;
a light source; and
a platform mounted above the light source, the graphic artwork display being mounted on top of the platform, the platform having a light aperture defined therein for passage of light from the light source through the platform and into the graphic artwork display for illuminating the first of the graphic images visible through the front mounting plate and illuminating the second of the graphic images visible through the rear mounting plate.

8. The lighted graphic artwork display according to claim 7, wherein said front mounting plate and said rear mounting plate are releasably attached to each other, whereby the first and second graphic images may be interchangeably replaced.

9. The lighted graphic artwork display according to claim 7, wherein said platform further comprises a pair of parallel elongate protrusions forming opposing sidewalls atop the platform, the graphic artwork display being retained between the sidewalls.

10. The lighted graphic artwork display according to claim 7, wherein the light source emits a plurality of colors of the visual spectrum when appropriate electrical power is applied thereto.

11. A lighted graphic artwork display, comprising:
a front mounting plate made from a light permeable material;
a rear mounting plate, the front and rear mounting plates being adapted for holding a first graphic image therebetween in order to form the graphic artwork display, the first of the graphic image being visible through the front mounting plate;
first indicia forming a text message appropriate to the first graphic image, the first indicia being engraved into the front mounting plate;
a light source; and,
a platform mounted above the light source, the graphic artwork display being mounted on top of the platform, the platform having a light aperture defined therein for passage of light from the light source through the platform and into the graphic artwork display for illuminating the first graphic image and the first indicia.

12. The lighted graphic artwork display according to claim 11, wherein the front and rear mounting plates have substantially smooth contact surfaces adapted for facing the first graphic image and the front and rear mounting plates have substantially identical geometric shapes and dimensions.

13. The lighted graphic artwork display according to claim 11, wherein said rear mounting plate is made from a light permeable material, the display further comprising an opaque backing material disposed between said front mounting plate and said rear mounting plate, whereby the display is adapted for holding the first graphic image between said front mounting plate and the opaque backing material for viewing through said front mounting plate and for holding a second graphic image between said rear mounting plate and the opaque backing material for viewing through said rear mounting plate, both the first and second graphic images being lit by said light source.

14. The lighted graphic artwork display according to claim 13, further comprising second indicia forming a text message appropriate to the second graphic image, the second indicia being engraved into the rear mounting plate.

15. The lighted graphic artwork display according to claim 11, wherein said front and rear mounting plates have a front surface having a clear finish.

16. The lighted graphic artwork display according to claim 11, wherein said front mounting plate and said rear mounting plate have beveled edges.

17. The lighted graphic artwork display according to claim 11, said front mounting plate and said rear mounting plate have a matte finish.

18. The lighted graphic artwork display according to claim 11, wherein said platform further comprises a pair of parallel elongate protrusions forming opposing sidewalls atop the platform, the graphic artwork display being retained between the sidewalls.
